(19) United States
(12) Patent Application Publication
(10) Pub. No.: US 2005/0052826 A1
(43) Pub. Date: Mar. 10, 2005

(54) Detachable electronic device mounting holder

(75) Inventor: Chieh-Shih Yi, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei (TW)

(21) Appl. No.: 10/703,598

(22) Filed: Nov. 10, 2003

(30) Foreign Application Priority Data
Sep. 9, 2003 (TW) 92216292

(51) Int. Cl. H02B 1/04

(52) U.S. Cl. 361/636

(57) ABSTRACT

A detachable electronic device mounting holder having an open chamber for holding an electronic device, the open chamber having a front open side and a rear open side for easy insertion of an electronic device and a cross bar at the rear open side for stopping the loaded electronic device in place, an elongated opening on an upper border of the mounting holder through which the electric wires of the electronic device are inserted into the open chamber and then extended out of the rear open side of the open chamber, and two U-shaped springy hooks respectively disposed at two sides for detachably securing the electronic device mounting holder to an apparatus case.

### BACKGROUND OF THE INVENTION

1. Field of the Invention

The present invention relates to an electronic device mounting holder and, more particularly, to a detachable electronic device mounting holder for mounting in the case of an electronic apparatus to hold an electronic device or the like that has electronic components exposed to the outside for operation or for producing sound and/or light waves.

2. Description of Related Art

A computer generally has various electronic devices disposed on the outside of the case for operation or observation by the user. These electronic devices may include LEDs (light emitting diodes), switches, wireless receivers, microphone jack, ear jack, etc.

FIG. 1 shows an application example of an electronic device mounting holder according to the prior art. According to this design, the electronic device mounting holder, referenced by 9, has an opening 91 and two hooks 92 at two sides of the opening 91. A switch 93 is mounted in the opening 91 inside the electronic device mounting holder 9, having electric wires 94 extended out of the rear side of the electronic device mounting holder 9. By means of the hooks 92, the electronic device mounting holder 9 is fastened to the apparatus case 95 to hold the switch 93 in place.

During installation, the electric wires 94 of the switch 93 are inserted through the electronic device mounting holder 9 and then soldered to the switch 93, and then the electric wires 94 are pulled backwards to set the switch 93 in the opening 91 inside the electronic device mounting holder 9, and then the electronic device mounting holder 9 is fastened to the apparatus case 95. This mounting procedure is complicated because the electric wires 94 and the switch 93 must be maintained disconnected before mounting. Further, when the switch 93 damaged, it cannot be directly removed from the electronic device mounting holder 9 for a replacement. At this time, the user must cut off the electric wires 94 from the switch 93 or the switch 93 from the electric wires 94 so that the switch 93 can be separated from the electronic device mounting holder 9 for a replacement.

Furthermore, because the hooks 92 are rigid hooks and hot springy, the user must employ much effort to squeeze the front ends 921 of the hooks 92 from the outside 951 of the apparatus case 95 and to further disengage the hooks 92 from the apparatus case 95.

Therefore, it is desirable to provide a detachable electronic device mounting holder, which eliminates the aforesaid problems.

### SUMMARY OF THE INVENTION

It is the main object of the present invention to provide a detachable electronic device mounting holder, which facilitates mounting/dismounting of the electronic device without causing damage to the electronic device. It is another object of the present invention to provide a detachable electronic device mounting holder, which can easily and detachably mounted in an apparatus case.

To achieve these and other objects of the present invention, the detachable electronic device mounting holder comprises a left sidewall, a right sidewall opposite to the left sidewall, and a bottom wall connected between the bottom sides of the left sidewall and the right sidewall, an upper border between the top sides of the left sidewall and the right sidewall. The left sidewall, right sidewall, bottom wall and upper border define an open chamber adapted to accommodate an electronic device inside. The open chamber has a front open side, a rear open side, and stop means disposed at the rear open side and adapted to stop the electronic device inside the open chamber. The upper border has an elongated opening extended from the front open side of the open chamber to the rear open side in communication with the open chamber. Further, two U-shaped springy hooks are respectively extended from the left sidewall and the right sidewall at two sides of the rear open side of the open chamber and curved forwards. The U-shaped springy hooks each have a front end terminating in a hooked portion for mounting.

During installation, the electric wires of the electronic device are directly inserted through the elongated opening at the upper border into the inside of the open chamber and then extended out of the rear open side of the open chamber, and then the electronic device is pushed backwards and received inside the open chamber and stopped at the stop means. When replacing the electronic device, directly push the electronic device out of the open chamber, and then pull the electric wires out of the open chamber through the elongated opening at the upper border. Therefore, the electronic device can easily be loaded in or unloaded from the electronic device mounting holder without causing damage.

Further, when fastening the electronic device mounting holder to the case of an electronic apparatus, squeeze the springy hooks with the fingers and then force the hooked portions of the springy hooks into the respective hook holes at the apparatus case, and then release the hand from the springy hooks, keeping the springy hooks secured to the apparatus case. By means of the springy hooks, the electronic device mounting holder can easily and detachably be installed in the apparatus case.

### BRIEF DESCRIPTION OF THE DRAWINGS

FIG. 1 shows an application example of an electronic device mounting holder according to the prior art.

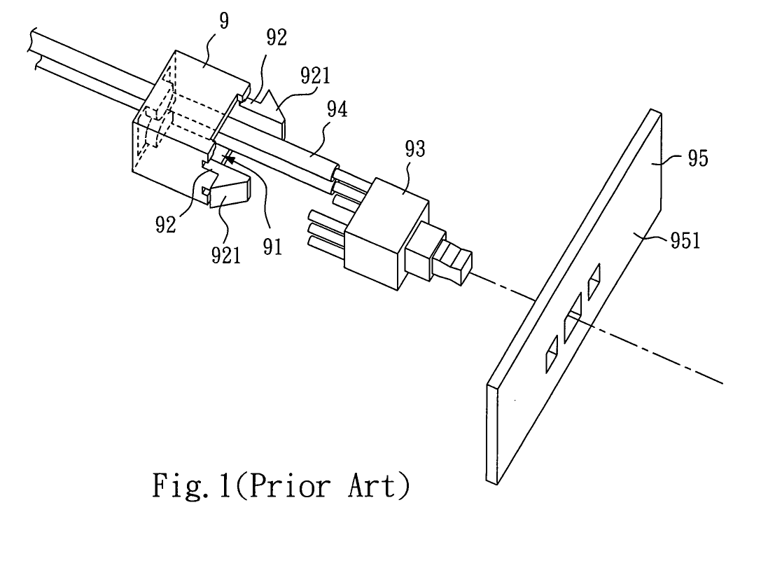

FIG. 2 is an application example of an electronic device mounting holder according to the present invention.

FIG. 3 is a perspective view of the electronic device mounting holder according to the present invention.

FIG. 4 illustrates the electronic device mounting holder fastened to the apparatus case according to the present invention.

FIG. 5 is a sectional view in an enlarged scale of FIG. 4.

FIG. 6 is an elevational view showing the use of an alternate form of the electronic device mounting holder with a circuit board according to the present invention.

### DETAILED DESCRIPTION OF THE PREFERRED EMBODIMENT

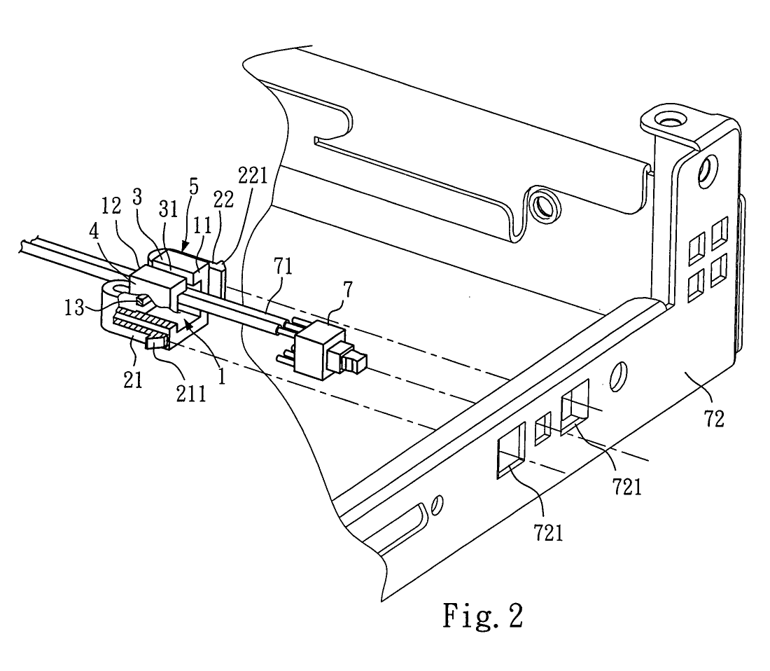

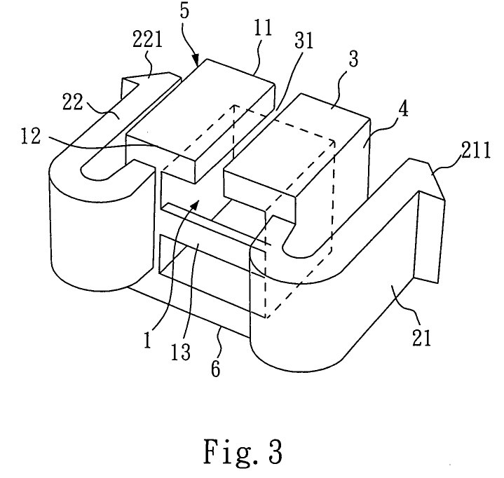

Referring to FIGS. 2 and 3, a detachable electronic device mounting holder in accordance with the first embodiment of the present invention is shown having a left sidewall 4, a right sidewall 5, a bottom wall 6, an upper border 3, and two U-shaped springy hooks 21 and 22.

As illustrated, the right sidewall 5 is disposed opposite to the left sidewall 4; the bottom wall 6 is connected between the bottom side of the left sidewall 4 and the bottom side of the right sidewall 5; the upper border 3 is between the top side of the left sidewall 4 and the top side of the right sidewall 5; the left sidewall 4, the right sidewall 5, the bottom wall 6 and the upper border 3 define an open chamber 1.

The aforesaid open chamber 1 has the front and rear sides opened, forming respectively a front end 11 and a rear end 12. The upper border 3 has an elongated opening 31 extended from the front end 11 of the open chamber 1 to its rear end 12 and disposed in communication with the open chamber 1. There is a stop member 13 disposed at the rear end 12 and protruding toward the inside of the open chamber 1. According to this embodiment, the stop member 13 is a cross bar.

Further, the two U-shaped springy hooks 21 and 22 are respectively curved outwards from the left sidewall 4 and the right sidewall 5 and then extended forwards in a substantially parallel relationship relative to the left and right sidewalls 4 and 5 and then terminating in a hooked portion 211 or 221.

Referring to FIG. 2 again, when installing an electronic device 7, for example a switch, the electric wires 71 of the electronic device 7 are inserted through the elongated opening 31 at the upper border 3 and then extended out of the rear end 12 of the open chamber 1, and then the electronic device 7 is pushed backwards toward the rear end 12 of the open chamber 1 and stopped at the stop member 13 inside the open chamber 1. When wishing to repair or replace the electronic device 7, push the electronic device 7 out of the open chamber 1, and then pull the electric wires 71 of the electronic device 7 out of the electronic device mounting holder through the elongated opening 31 at the upper border 3. Therefore, the electronic device 7 can conveniently loaded in or unloaded from the electronic device mounting holder simply by pushing the electronic device 7 into or out of the open chamber 1 of the electronic device mounting holder without causing damage to the electronic device 7.

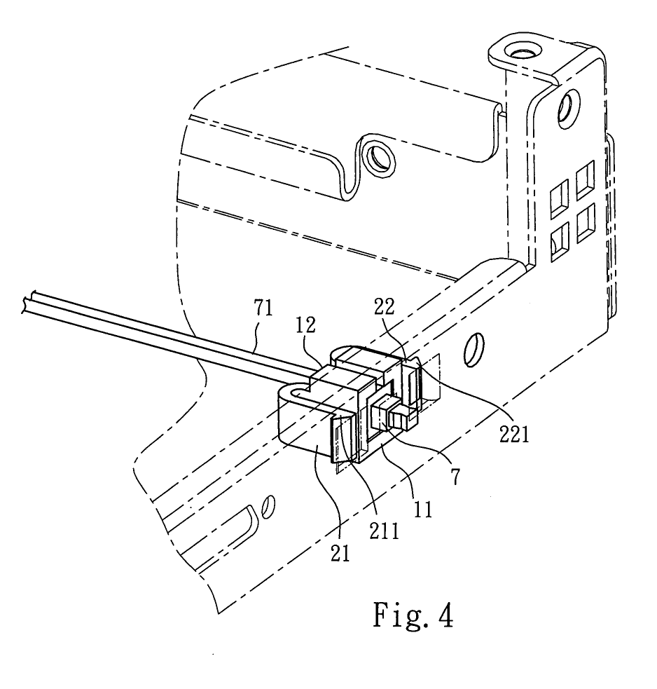

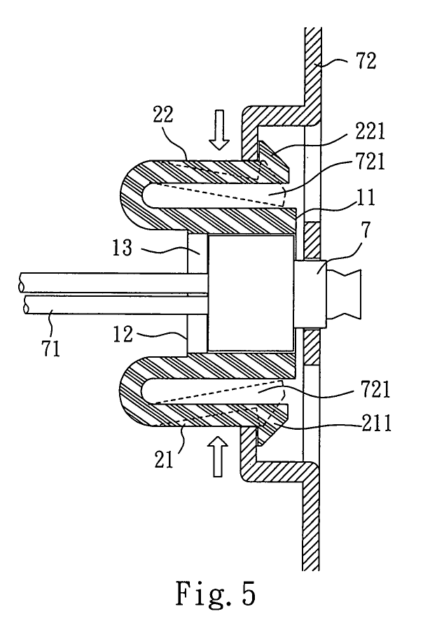

FIG. 4 is a schematic drawing showing an application example of the second embodiment of the present invention. FIG. 5 is a sectional view in an enlarged scale of FIG. 4. And referring to FIG. 2 again, when installing the electronic device 7 with the electronic device mounting holder, squeeze the spring hooks 21 and 22 with the fingers, and then force the hooked portions 211 and 221 of the springy hooks 21 and 22 into engagement with respective hook holes 721 at the apparatus case 72, and then release the hand from the springy hooks 21 and 22. At this time, the springy hooks 21 and 22 return to their former shape, keeping the hooked portions 211 and 221 hooked in the hook holes 721 at the apparatus case 72. When removing the electronic device mounting holder from the apparatus case 72, squeeze the springy hooks 21 and 22 with the fingers to disengage the hooked portions 211 and 221 from the hook holes 721 of the apparatus case 72, and then remove the electronic device mounting holder and the electronic device 7 from the apparatus case 72.

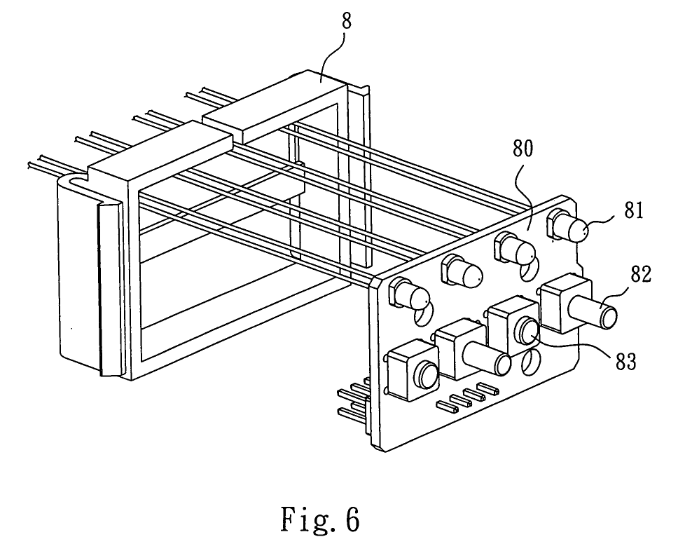

FIG. 6 shows an alternative form of the present invention. According to this alternate form, the electronic device mounting holder, referenced by 8, is adapted to hold a circuit board, referenced by 80, which comprises a plurality of LEDs (light emitting diodes) 81, switches 82, infrared receiving elements 83, and etc. This embodiment achieves the same effect as the aforesaid first embodiment of the present invention did. Therefore, the electronic device mounting holder can be made in any of a variety of sizes to fit any of a variety of electronic devices.

As indicated above, the electronic device mounting holder of the present invention can be alternatively made to fit any of a variety of electronic devices for use in any of a variety of electronic apparatus, for example, LED display, switch panel, wireless receiver, electric socket, small display module, or the like that has electronic components exposed to the outside for operation or for producing sound and/or light waves.

Although the present invention has been explained in relation to its preferred embodiment, it is to be understood that many other possible modifications and variations can be made without departing from the spirit and scope of the invention as hereinafter claimed.

1. A detachable electronic device mounting holder comprising:
a left sidewall, said left sidewall having a bottom side and a top side;
a right sidewall opposite to said left sidewall, said right sidewall having a bottom side and a top side;
a bottom wall connected between the bottom sides of said left sidewall and said right sidewall;
an upper border between the top sides of said left sidewall and said right sidewall; wherein said left sidewall, said right sidewall, said bottom wall and said upper border define an open chamber adapted to accommodate an electronic device inside, said open chamber having a front open side, a rear open side, and stop means disposed at said rear open side and adapted to stop said electronic device inside said open chamber; said upper border has an elongated opening extended from said front open side to said rear open side in communication with said open chamber; and
two U-shaped springy hooks are respectively extended from said left sidewall and said right sidewall at two sides of said rear open side of said open chamber and curved forwards, said U-shaped springy hooks each having a front end terminating in a hooked portion for mounting.

2. The detachable electronic device mounting holder as claimed in claim 1, wherein said electronic device having electric wires inserted into said open chamber through said elongated opening of said upper border and extended out said rear open side of said open chamber when said electronic device stopped at said stop means.

3. The detachable electronic device mounting holder as claimed in claim 2, wherein said electronic device is a switch.

4. The detachable electronic device mounting holder as claimed in claim 2, wherein said electronic device is a circuit board, said circuit board having at least one light emitting diode thereon.

5. The detachable electronic device mounting holder as claimed in claim 1, wherein said stop means is a cross bar.
